(19) United States
(12) Patent Application Publication
(10) Pub. No.: US 2018/0227206 A1
(43) Pub. Date: Aug. 9, 2018

(54) EXTENT OF OUT-OF-SEQUENCE INDICATION FOR MULTI-CONNECTIVITY

(71) Applicant: Nokia Technologies Oy, Espoo (FI)

(72) Inventor: Anand BEDEKAR, Glenview, IL (US)

(21) Appl. No.: 15/749,310

(22) PCT Filed: Aug. 21, 2015
(86) PCT No.: PCT/US2015/046338

§ 371 Date: Jan. 31, 2018

(51) Int. Cl. H04L 12/26; H04L 12/801; H04L 12/709; H04L 12/803

(52) U.S. Cl. CPC H04L 43/0847; H04L 43/0894; H04L 47/283; H04L 45/245; H04L 47/122; H04L 47/34

(57) ABSTRACT

Embodiments concern indication of extent of out-of-sequencing for multi-connectivity. While receiving control plane or user plane packets from multi-connectivity legs, a specific user-plane packet may be determined to be an out-of-sequence packet if the packet is received too early or too late. The receiver may keep a per-leg counter of number of out-of-sequence packets and a total count of packet received. An indication message may be sent to indicate multi-connectivity legs which are generating early or late packets. The sender then may adjust its data flow partitioning policy across multi-connectivity legs until the percentage or fraction of out-of-sequence packets is below a desired threshold.

### TECHNOLOGICAL FIELD

The described invention relates to wireless communications, and more particularly to the indication of extent of out-of-sequencing for multi-connectivity which can improve the flow throughput in wireless systems such as the fifth generation (5G) system currently under development.

### BACKGROUND

When assessing the current state of data communications with a view towards setting goals and framework for developing the 5G wireless system from current Long Term Evolution/Long Term Evolution-Advanced (LTE/LTE-A) systems, Radio Access Network (RAN) architecture enhancement was identified as one of the targets for 5G network. In 5G RAN it is anticipated that there can be multiple serving cells per user equipment (UE), and that a single UE can have simultaneous connections to multiple local access points. It follows that multi-connectivity is an important feature for 5G RAN architecture. Configuring separate partition ratio for each data flow across multi-connectivity legs in a practical communication system is one aspect of these teachings.

### SUMMARY

According to one aspect of these teachings there is an apparatus comprising at least one processor and at least one memory including computer program code. The at least one memory and the computer program code are configured with the at least one processor to cause the apparatus to a) determine whether a packet is out-of-sequence relative to packets from at least one multi-connectivity leg based on sequence numbers of packets received from a sender; b) record a measure of the out-of-sequence packet and a measure of the received packets for the at least one multi-connectivity leg; and c) transmit an out-of-sequence indication message to the sender.

According to another aspect of these teachings there is a method for indicating the extent of out-of-sequencing for multi-connectivity, the method comprising: determining whether a packet is out-of-sequence relative to packets from at least one multi-connectivity leg based on sequence numbers of packets received from a sender; recording a measure of the out-of-sequence packet and a measure of the received packets for the at least one multi-connectivity leg; and transmitting an out-of-sequence indication message to the sender.

According to a further aspect of these teachings there is a computer readable memory having stored therewith computer program code, which when executed controls a communication device to at least: a) determine whether a packet is out-of-sequence relative to packets from at least one multi-connectivity leg based on sequence numbers of packets received from a sender; b) record a measure of the out-of-sequence packet and a measure of the received packets for the at least one multi-connectivity leg; and c) transmit an out-of-sequence indication message to the sender.

In a still further aspect of these teachings there is an apparatus comprising determining means for determining whether a packet is out-of-sequence relative to packets from at least one multi-connectivity leg based on sequence numbers of packets received from a sender; recording means for recording a measure of the out-of-sequence packet and a measure of the received packets for the at least one multi-connectivity leg; and transmitting means for transmitting an out-of-sequence indication message to the sender.

These and other aspects are detailed below with particularity.

### BRIEF DESCRIPTION OF THE DRAWINGS

FIG. 1 is a block diagram illustrating an example architecture of a multi-connectivity with radio stack showing logical flows of a service flow and illustrates how these packets of a service flow get partitioned according to embodiments of these teachings.

FIG. 2 is a diagram of a radio stack showing the partition of service flow through multiple legs for the multi-connectivity and the flow of out-of-sequence indication message in 5G, and can be used for implementing certain embodiments of these teachings.

FIG. 3 is a messaging diagram illustrating a representative out-of-sequence transmission procedure suitable for carrying out these teachings.

FIG. 4 is a schematic block diagram of radio communication devices suitable for carrying out embodiments of the teachings herein.

### DETAILED DESCRIPTION

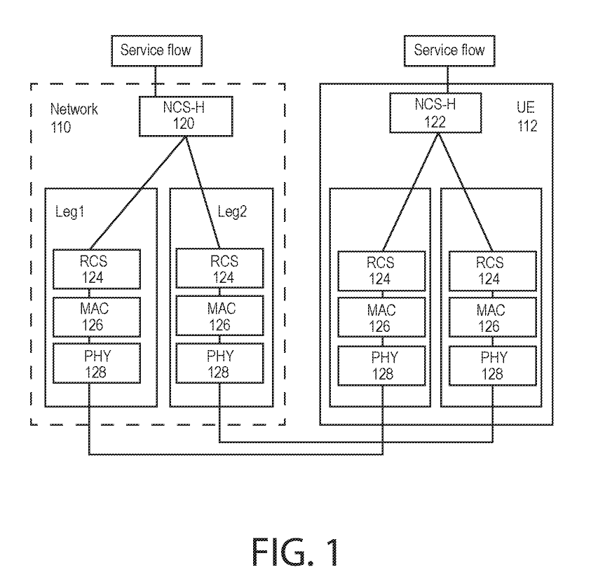

FIG. 1 is a block diagram illustrating an example architecture of a multi-connectivity suitable for carrying out these teachings. The diagram illustrates the multi-connectivity between an access network 110 and a user equipment (UE) 112 with Network Convergence Sub-layer (NCS) (or NCS-H 120/122) functional module acting as multi-connectivity anchor. NCS-H 120 has to decide how to partition each flow across the multi-connectivity legs of a given UE to maximize flow throughput, as well as to minimize outage if a given link goes down. NCS-H 120 can split individual flows across multiple links While FIG. 1 depicts two legs for the purpose of simplicity, one skilled in the art will understand that a multi-connectivity may comprise any plurality of legs.

Packets of a flow partitioned across multi-connectivity legs may reach the receiving NCS-H 122 out of sequence since different radio legs have different random fluctuations. For many types of flows, the sending NCS-H 120 may need to ensure that packets do not reach the receiving NCS-H 122 too far out of sequence. This is true for Transport Control Protocol (TCP)-type flows, as well as other traffic for example User Datagram Protocol (UDP)-based Voice over Internet Protocol (VoIP), gaming, etc. The receiving NCS-H 122 will re-sequence the packets before delivering them to the upper layer. NCS-H may serve control plane data in the same manner as the user plane (UP) data.

The NCS of Layer 2 in 5G is similar to Packet Data Convergence Protocol (PDCP) in Evolved UMTS Radio Access Network (E-UTRAN), commonly known as Long Term Evolution (LTE). NCS in 5G is designated to be somewhat TCP/IP and application aware, and is able to monitor and filter out individual TCP/IP packets and sub-flows as well as carry context information of upper layers passed down to the NCS by corresponding upper layers such as the application scheduler and user gateway. NCS-H 122 at the UE side is the first or earliest possible Radio Access Network (RAN)-level entity which may be configured to monitor and filter out individual application packets and service flows originated from the UE for the uplink traffic. Similar to services provided by PDCP, NCS may provide functionality such as ciphering and header compression to its upper layers.

Radio Convergence Sublayer (RCS) 124 of layer 2 is similar to the Radio Link Control (RLC) in E-UTRAN that handles the buffers and reports the various buffer status to the Medium Access Control (MAC) 126 entity. In between the RCS 124 and the PHY layer 128 is the MAC layer 126 at which the Quality of Service (QoS)-aware scheduling of packets for transmission over the air is done, and in 4G and 5G this scheduling involves mapping the UP packets to the transport blocks (TBs) before passing them to the PHY layer 128. The MAC scheduler maps the UP packets from the applications, for transmission according to their respective priorities. The functionality mentioned herein may be provided by protocols that are named differently, and protocol names may change over time. For example, the NCS-H may be named as just NCS or something else. The RCS may be named as RLC or as something else. The nomenclature of protocols are examples to illustrate the functionality of interest.

While upper-level protocols like TCP can withstand some level of out-of-sequencing, For NCS layer, out-of-sequence are problematic due to the following reasons. First, if the packets are received from the lower layers very far out of sequences, then the receiving NCS-H has to hold on to these packets for significant amount of time waiting for the missing packets to do the resequencing, and in extreme cases (e.g. discard timer expiry), these packets are dropped. Further, header de-compression and deciphering at the receiving NCS may hit stall due to too many out-of-sequencing. The amount of out-of-sequencing that may be tolerated varies for different type of data flows.

What is needed is an efficient mechanism to allow sending NCS-H to make intelligent decision on how to partition a flow across multi-connectivity legs, so as to limit the out-of-sequencing at the receiving NCS-H to a desired value and to allow flexible control of the amount of resequencing, to accommodate different needs of different types of traffic. In one example, the mechanism may be symmetric such that it works for both uplink and downlink In another example, the mechanism may work in the presence of variable delays, both on network paths (e.g. backhaul links) as well as on the radio links, for example, with hybrid automatic repeat request (HARQ) retransmissions, fluctuating modulation and coding scheme (MCS), etc.

On downlink, NCS-H 120 gets flow-control information from lower layers. This can include “sojourn time” which is the expected value of a delay along a path plus queueing delay. This information can also include the throughput of a link, and other radio characteristics. But these can be at best be approximate values because radio link throughput fluctuates a lot due to fading as well as due to MAC scheduling, and so actual queueing delay experienced by any given packet can be very different from the expected queueing delay.

Furthermore, network path delays between NCS-H 120 and RCS 124 can be variable due to congestion on a backhaul network especially if the backhaul itself is a wireless link (e.g. in 5G the access point (AP) is expected to be self-backhauling). Due to these factors, the flow control information including expected link throughput and sojourn time are at best approximations. So these may be inadequate for downlink NCS-H 120 to ensure that the amount of out-of-sequencing is controlled to a given desired value.

In downlink as well as uplink, the sending RCS of each multi-connectivity leg provides the sending NCS-H information about successful delivery of a packet whenever that leg's sending RCS receives an ACK status message from that leg's receiving RCS. But the ACK/NAK status Protocol Data Units (PDUs) sent by the receiving RCS are typically “batch messages”. To reduce signaling overhead they are for example sent after every N packets. When sending RCS gets an acknowledgement message, it gets so for N packets at a time, and it cannot tell how many of those packets were received out of sequence, or in what chunks they were delivered to the receiving NCS-H.

Further, on a downlink, due to variable network delays, the sending NCS-H may receive this ACK information after some unpredictable delay. Also, for some delay-sensitive traffic, unacknowledged-mode may be used at RCS. Due to these factors, knowledge of the successful acknowledgment of a packet may not give a good indication to the sending NCS-H to ensure that the amount of out-of-sequencing is controlled to a given desired value.

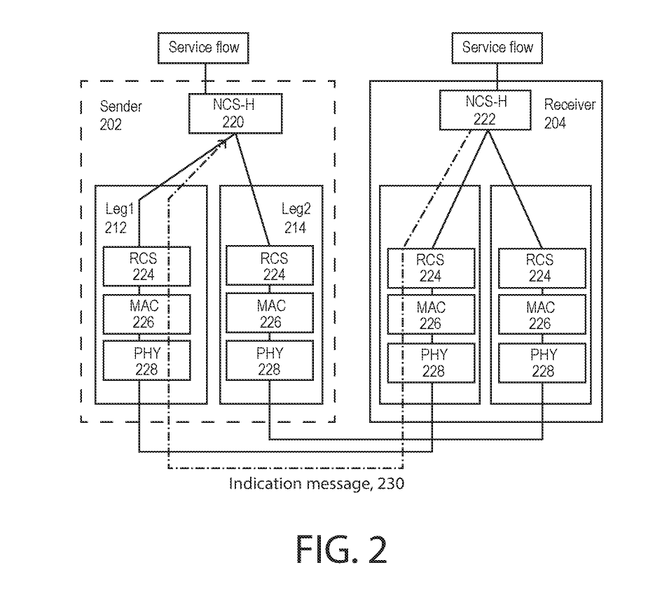

In view of the above, embodiments of these teachings provide an effective messaging method from receiving NCS-H to sending NCS-H to indicate the amount of out-of-sequencing observed in the received packets by the receiving NCS-H. FIG. 2 is a block diagram showing the partition of service flow through Leg1 212 and Leg2 214 for packets from sender 202 to the receiver 204. To the left of FIG. 2 are the logical layers for each leg: NCS-H 220 is the highest and PHY layer 228 is the lowest at which the data is transmitted over the air. The NCS-H layer 220 partitions data packets from the application service flow according to their respective partition ratio. For the case of two legs as shown in FIG. 2 with Leg1 212 and Leg2 214, there may be separate buffers per sub-flow.

In general terms, some embodiments comprise providing in the indication message 230 a percentage or fraction of packets that are out-of-sequence. The indication may also be normalized to a suitable scale like e.g. {0, 1, 2, 3, 4}. The indication may for example indicate an indicatable value nearest to a determined value or an indication that the determined value is above or below one of at least one threshold or within a range of two of at least two thresholds. The indication may comprise a single indication, or an individual indication for each of a plurality of legs. An indication message 230 may also give indications or rank-ordering of multi-connectivity legs which are generating most late packets. In one embodiment, the message 230 can be sent using Radio Resource Control (RRC) signaling, in-band signaling, or NCS signaling (e.g. special header field within the NCS header).

In another embodiment, indication message 230 can be sent over any multi-connectivity leg. The NCS-H receiver 222 can choose which leg based on various criteria, e.g. reliability or latency etc. In another embodiment, a preferred or required leg may be indicated by the transmitting NCS-H 220. In a further embodiment, the indication message 230 may be sent at sub-service-flow level, when sender NCS-H 220 is using in-service-flow differentiation for QoS purposes.

According to certain embodiments of these teachings, the sender NCS-H 220 that adjusts its policy of flow partitioning across multi-connectivity legs after receiving an out-of-sequence indication message 230. Sender NCS-H 220 may reduce the amount of traffic sent to that leg which is typically the most late, and send them over legs which are early instead. Sender NCS-H 220 may continue to adjust the ratio of the flow until the percentage or fraction of out-of-sequence packets is below a desired threshold. In some embodiments, the receiver NCS-H 222 may provide information to the sender NCS-H2 220 on the desired threshold.

In another embodiment, the sender NCS-H 220 may send signaling to the receiver NCS-H 222 to provide information such as when to turn on or off out-of-sequence indication messaging, whether to activate out-of-sequence indication messaging, and threshold of extent of out-of-sequencing to use for each sub-flow according to these teachings. Whenever a new sub-flow is created, the sender NCS-H 220 may configure the above parameters for the new sub-flow and signals them to the receiver NCS-H 222.

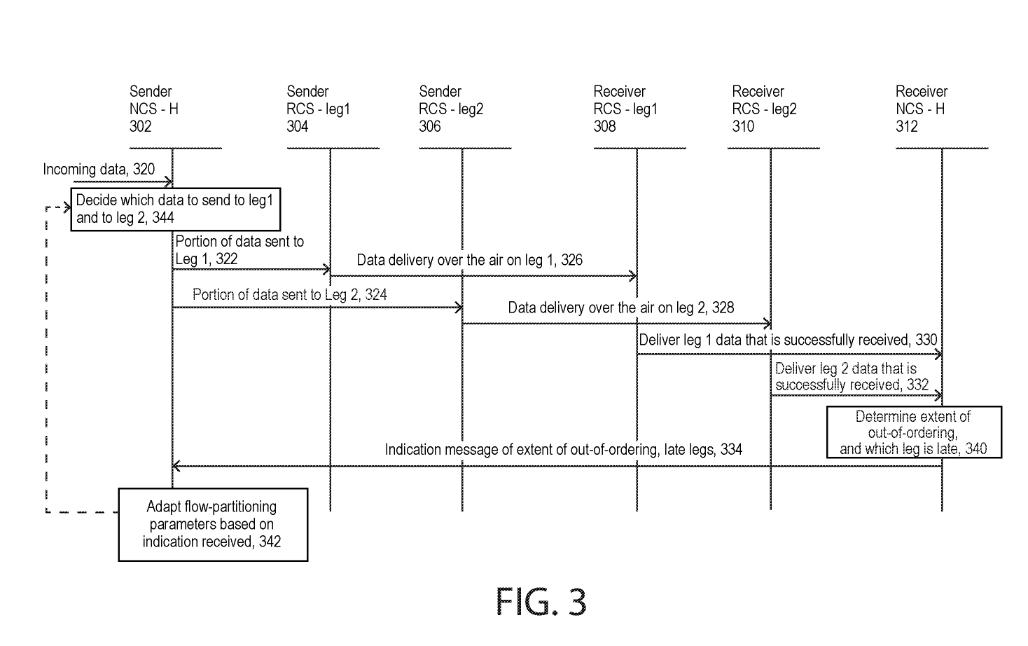

Whatever the logical arrangement of the radio stack, the advantageous effects of implementing the broader aspects of these teachings are similar. There are a variety of ways to implement these teachings. FIG. 3 is an example messaging flow diagram that illustrates some of the above aspects of these teachings. Whenever the receiver NCS-H 312, however implemented, based on sequence numbers in NCS-Data 330 & 332 (inserted by sender NCS-H 302) received from RCS leg1 308 and RCS leg2 310, determines that a packet is received from an RCS of a given leg before a previous packet based on sequence numbers inserted by sender NCS-H 302 (i.e. with lower sequence number) from another leg. This is a “too-early” indication. Conversely it is also possible to keep the count based on “too-late” indication. The receiver NCS-H 312 keeps a per-leg counter of number of out-of-sequence packets or bytes based on this determination, and a total count of number of packets or bytes received.

In block 340, the receiver for example NCS-H determines the extent of out-of-ordering, and which leg is typically late. At certain instants, either periodically based on a configured timer or when a threshold is exceeded or based on a request from the sender NCS-H 302, receiver NCS-H 312 provides an indication message 334 to the sender NCS-H 302. This indication message 334 may comprise the fraction of out-of-sequencing experienced on each leg, e.g. ratio of that leg's out-of-sequence count relative to the total number of packets. Furthermore, possibly on per-leg basis, an indication of which other leg is generating the most packets out-of-sequence relative to that leg may also be included.

At sender NCS-H 302, the incoming data traffic/packets of a UE (or service-flow/sub-flow) 320 is split across N legs in ratio of f1:f2 . . . :fN wherein f1+f2+. . . +fN=1 either at byte-count level or packet-count level. N equals to 2 in the example illustrated by FIG. 3. In another example, packets may be replicated across multiple legs to ensure reliability of delivery to the receiver, in which case f1+f2+. . . +fN>1. When indication is received from the receiver NCS-H 312, sender NCS-H 302 adjusts its policy of flow partitioning across multi-connectivity legs as in block 342.

If the out-of-sequencing level reported for leg i is greater than a threshold, sender NCS-H 302 may select the leg i for which ratio fi for leg i is adjusted up if “too-early” indications are used, or adjusted down if “too-late” indication are used. Correspondingly select a leg j for which the ratio fj is adjusted down (if “too-early” indication) or up (if too-late indication). Leg i can be chosen based on various criteria, for example, the leg which has most too-early packets. Leg j can be chosen relative to leg i, for example, the one which has least too-early packets. Using the adjusted partitioning policy, the sender NCS-H 302 starts forwarding the data packets to RCS legs 304 & 306 based on the policy as in block 344. Sender NCS-H 302 continue to do this adjustment until the percentage of out-of-sequence packets is below a desired threshold.

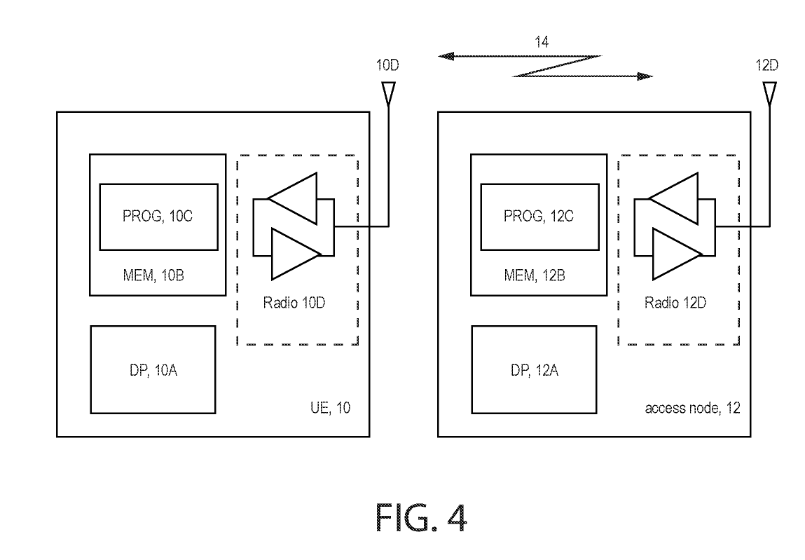

FIG. 4 is a schematic block diagram of radio communication devices suitable for carrying out embodiments of the teachings herein. In the illustrated wireless system a wireless network including an access node 12 is adapted for communication over a wireless link 14 with an apparatus, such as a mobile communication device which may be referred to as a UE 10. The network may include a network control element (NCE) that includes mobility management and serving gateway functionality, and which provides connectivity with another network such as a telephone network and/or a data communications network such as the internet.

The UE 10 includes a controller, such as a computer or a data processor (DP) 10A, a computer-readable memory medium embodied as a memory (MEM) 10B that stores a program of computer instructions (PROG) 10C, and a suitable wireless interface such as radio 10D (shown as a transmitter and receiver) for bidirectional wireless communications with the access node 12 via one or more antennas 10D.

Similarly the access node 12 also includes a controller, such as a computer or a data processor (DP) 12A, a computer-readable memory medium embodied as a memory (MEM) 12B that stores a program of computer instructions (PROG) 12C, and a suitable wireless interface such as a radio 12D (shown as a transmitter and receiver) for bidirectional wireless communications with the UE 10 via one or more antennas 12D. The access node 12 may be coupled via a data/control path to the NCE (not shown) as well as to other access nodes via similar peer data/control paths.

At least one of the PROGs 10C, 12C is assumed to include program instructions that, when executed by the associated DP, enable the device to operate in accordance with exemplary embodiments of this invention, as detailed above by example. That is, various exemplary embodiments of this invention may be implemented at least in part by computer software executable by the DP 10A of the UE 10; by the DP 12A of the access node 12, and/or by the DP of the NCE (not shown), or by hardware, or by a combination of software and hardware (and firmware). The NCE is assumed to have a DP, MEM and PROG as discussed above, and to communicate to the access node 12 via a modem and the data/control path or interface.

For the purposes of describing various exemplary embodiments in accordance with this invention the UE 10 and the access node 12 may also include dedicated processors, for example in the radio 10D/12D or elsewhere. Such dedicated modules may be constructed so as to operate in accordance with various exemplary embodiments detailed herein.

The DPs 10A and 12A may be of any type of circuitry comprising interconnected logical gates that is suitable to the local technical environment, and may include one or more of general purpose computers, special purpose computers, microprocessors, digital signal processors (DSPs) and processors based on a multicore processor architecture, as non-limiting examples. For example, the DPs may comprise any of a determining circuit, a recording circuit, an adjusting circuit, a configuring circuit and a reducing circuit in accordance with various embodiments of the present invention. The wireless interfaces (e.g., radios 10D and 12D) may be of any type suitable to the local technical environment and may be implemented using any suitable communication technology such as individual transmitters, receivers, transceivers or a combination of such components.

In general, the various embodiments of the UE 10 can include, but are not limited to, smart phones whether handheld, wearable on the body or implantable within the user's body in whole or in part; other cellular telephones; personal digital assistants (PDAs) having wireless communication capabilities; portable computers having wireless communication capabilities including laptops, palmtops, tablets and e-readers; image capture devices such as digital cameras having wireless communication capabilities; gaming devices having wireless communication capabilities; music storage and playback appliances having wireless communication capabilities; Internet appliances permitting wireless Internet access and browsing; as well as portable units or terminals that incorporate combinations of such functions.

The computer readable MEMs 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. Any combination of one or more computer readable medium(s) may be utilized as a memory 10B/12B. The computer readable medium may be a computer readable signal medium or a non-transitory computer readable storage medium. A non-transitory computer readable storage medium does not include propagating signals and may be, for example, but not limited to: an electronic, magnetic, optical, electromagnetic, infrared, or semiconductor system, apparatus, or device; or any suitable combination of the foregoing.

A more specific but non-exhaustive list of examples for the computer readable storage medium include: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1-40. (canceled)

41. An apparatus comprising:
at least one processor; and
at least one memory including computer program code, the at least one memory and the computer program code configured to, with the at least one processor, cause the apparatus at least to:
determine whether a packet is out-of-sequence relative to packets from at least one multi-connectivity leg based on sequence numbers of packets received from a sender;
record a measure of the out-of-sequence packet and a measure of the received packets for the at least one multi-connectivity leg; and
transmit an out-of-sequence indication message to the sender.

42. The apparatus according to claim 41, wherein the out-of-sequence packet is determined based on at least one of an early arrival of the packet and a late arrival of the packet during a resequencing of the received packets.

43. The apparatus according to claim 41, wherein the indication message indicates a percentage or fraction of the measure of the out-of-sequence packets relative to the measure of the received packets for at least one multi-connectivity leg.

44. The apparatus according to claim 41, wherein the indication message indicates a rank ordering of the multi-connectivity legs according to the measure of out-of-sequence packets.

45. The apparatus according to claim 41, wherein the indication message is sent over at least one multi-connectivity leg by at least one of radio resource control signaling and in-band signaling.

46. The apparatus according to claim 41, wherein the recorded measure of the out-of-sequence packets is a number of bytes corresponding to out-of-order packets.

47. The apparatus according to claim 41, wherein the transmitting further comprises:
transmit the out-of-sequence indication message to the sender based on a timer or at least one threshold.

48. An apparatus comprising:
at least one processor; and
at least one memory including computer program code, the at least one memory and the computer program code configured to, with the at least one processor, cause the apparatus at least to:
receive an indication message which indicates out-of-sequencing for at least one multi-connectivity leg from a receiver; and
adjust a flow partition policy of at least one of the at least one multi-connectivity leg based on the indication message.

49. The apparatus according to claim 48, wherein the adjusting flow partition policy further comprises:
reduce an amount of traffic for a multi-connectivity leg which has high out-of-sequencing based on the received indication message.

50. The apparatus according to claim 48, wherein the at least one memory and computer program instructions are further configured to, with the at least one processor, cause the apparatus to:
configure out-of-sequence parameters which comprise at least one of a threshold of extent of out-of-sequencing to use for each service flow, when to activate out-of-sequence indication messaging and whether to activate out-of-sequence indication messaging; and
transmit the out-of-sequence parameters to the receiver.

51. The apparatus according to claim 48, wherein the indication message indicates a percentage or fraction of the measure of the out-of-sequence packets relative to the measure of the received packets for at least one multi-connectivity leg.

52. The apparatus according to claim 48, wherein the indication message indicates a rank ordering of the multi-connectivity legs according to the measure of out-of-sequence packets.

53. The apparatus according to claim 48, wherein the indication message is sent over at least one multi-connectivity leg by at least one of radio resource control signaling and in-band signaling.

54. A method for indicating an extent of out-of-sequencing for multi-connectivity, the method comprising:
determining whether a packet is out-of-sequence relative to packets from at least one multi-connectivity leg based on sequence numbers of packets received from a sender;
recording a measure of the out-of-sequence packet and a measure of the received packets for the at least one multi-connectivity leg; and
transmitting an out-of-sequence indication message to the sender.

55. The method according to claim 54, wherein the out-of-sequence packet is determined based on at least one of an early arrival of the packet and a late arrival of the packet during a resequencing of the received packets.

56. The method according to claim 54, wherein the indication message indicates a percentage or fraction of the measure of the out-of-sequence packets relative to the measure of the received packets for at least one multi-connectivity leg.

57. The method according to claim 54, wherein the indication message indicates a rank ordering of the multi-connectivity legs according to the measure of out-of-sequence packets.

58. The method according to claim 54, wherein the indication message is sent over at least one multi-connectivity leg by at least one of radio resource control signaling and in-band signaling.

59. The method according to claim 54, wherein the recorded measure of the out-of-sequence packets is a number of bytes corresponding to out-of-order packets.

60. The method according to claim 54, wherein the transmitting further comprises:
transmitting the out-of-sequence indication message to the sender based on a timer or at least one threshold.
